(19) United States
(12) Patent Application Publication
(10) Pub. No.: US 2025/0131388 A1
(43) Pub. Date: Apr. 24, 2025

(54) SYSTEM FOR AN INTEGRATED TEAM CALENDAR

(71) Applicant: KISHORE DAGGUBATI, Danville, CA (US)

(72) Inventors: KISHORE DAGGUBATI, Danville, CA (US); VENKATA N, PLEASANTON, CA (US)

(73) Assignee: KISHORE DAGGUBATI, Danville, CA (US)

(21) Appl. No.: 18/489,022

(22) Filed: Oct. 18, 2023

(51) Int. Cl. G06Q 10/1093

(52) U.S. Cl. CPC G06Q 10/1095

(57) ABSTRACT

A system for an integrated team calendar is disclosed. The system comprises a first agent processing system, a second agent processing system, a first user processing system, and a server. The first agent processing system, the second agent processing system, and the first user processing system is associated with a first agent, a second agent, and a first user, respectively. The server is configured to retrieve a first and a second availability-time slot associated with the first agent and the second agent, respectively, wherein an availability status associated with the first agent and the second agent, is Available. The sever is configured to generate a consolidated calendar and display the same, on the first user processing system, wherein the calendar comprises of the first and second availability-time slot.

### FIELD OF THE INVENTION

This application relates generally to the field of scheduling appointments via digital calendar systems and more particularly, the system relates to scheduling an appointment via an integrated team calendar system.

### BRIEF STATEMENT OF THE PRIOR ART

In our increasingly interconnected world, effective time management is essential for personal, professional, and organizational success. Traditional calendar applications have played a pivotal role in helping users schedule their commitments. However, these applications predominantly cater to individual needs and often struggle to address the complexities of coordinating schedules among multiple users.

Existing calendar systems usually operate in isolation, requiring users to rely on disjointed methods such as emails, messages, or external scheduling tools to synchronize their activities with others. These disjointed approaches are not only time-consuming but also prone to miscommunication, leading to missed appointments and scheduling conflicts.

Moreover, the prior art in the field of digital calendar systems primarily comprises standalone applications designed to cater to the scheduling needs of individual users. While these existing systems serve their purpose effectively for single-user scenarios, they struggle to provide a comprehensive solution for multi-user scheduling and collaboration.

The need for an integrated Calendar System that seamlessly brings together the schedules and commitments of multiple users into a unified platform is evident. Such a system should leverage cutting-edge technology to enable users to collaborate effortlessly, optimize scheduling efficiency, and create a user-friendly environment for managing appointments and events collectively.

### SUMMARY OF THE INVENTION

In an embodiment, a system for an integrated team calendar. The system comprises a first agent processing system, a second agent processing system, a first user processing system, and a server. The first agent processing system is associated with a first agent, the second agent processing system is associated with a second agent, the first user processing system is associated with a first user. The server comprising one or more processors is configured to retrieve a first availability-time slot and a second availability-time slot associated with the first agent and the second agent respectively, when an availability status associated with the first agent and the second agent is Available. Further, the server is configured to generate a consolidated calendar comprising of the first availability-time slot and the second availability-time slot. Upon generating the consolidated calendar, the server is configured to display, on the first user processing system, the consolidated calendar to the first user.

### BRIEF DESCRIPTION OF DRAWINGS

Embodiments are illustrated by way of example and not limitation in the figures of the accompanying drawings, in which like references indicate similar elements and in which:

FIG. 1 illustrates a system 100 for displaying an integrated team calendar, in accordance with an embodiment.

FIG. 2 is a block diagram illustrating an architecture of a first agent processing system 102, in accordance with an embodiment.

FIG. 3 is a block diagram illustrating an architecture of a first user processing system 114, in accordance with an embodiment.

FIG. 4 is a block diagram illustrating an architecture of a server 110, in accordance with an embodiment.

FIG. 5 is a flowchart 500 illustrating scheduling of the appointment via the system 100, in accordance with an embodiment.

FIG. 6 is a flowchart 600 illustrating scheduling of the appointment when the first availability-time slot aligns with the second availability-time slot, in accordance with an embodiment.

FIG. 7 is a flowchart 700 illustrating re-scheduling the appointment of the first user 112 by the first agent 104, in accordance with an embodiment.

FIG. 8 is a flowchart 800 illustrating scheduling of the appointment by the first user 112, in accordance with an example embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

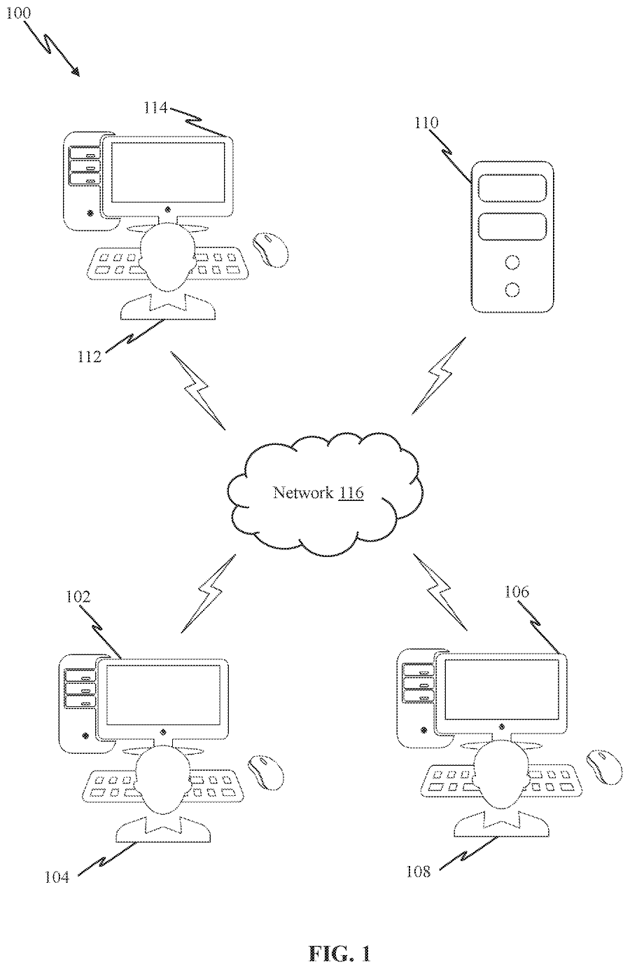

FIG. 1 illustrates a system 100 for displaying an integrated team calendar, in accordance with an embodiment. The system 100 may comprise of a first agent processing system 102, a second agent processing system 106, a first user processing system 114, and a server 110. The first agent processing system 102 may be associated with a first agent 104 and the second agent processing system 106 may be associated with a second agent 108. The first user processing system 114 may be associated with a first user 112. The server 110 may be configured to generate a consolidated calendar and display the same on the first user processing system 114. The first user processing system 114, the first agent processing system 102, the second agent processing system 106 and the server 110 may be connected and may be configured to communicate with each other through a network 116. The network 116 may be, but not limited to, a local area network, wide area network or a metropolitan area network.

In another embodiment, the system 100 may further comprise of a third agent processing system associated with a third agent, a fourth agent processing system associated with a fourth agent, and so on (not shown in the figures).

In an embodiment, the system 100 may further comprise of a second user processing system, associated with a second user, a third user processing system associated with a third user, a fourth user processing system associated with a fourth user, and so on (not shown in the figures).

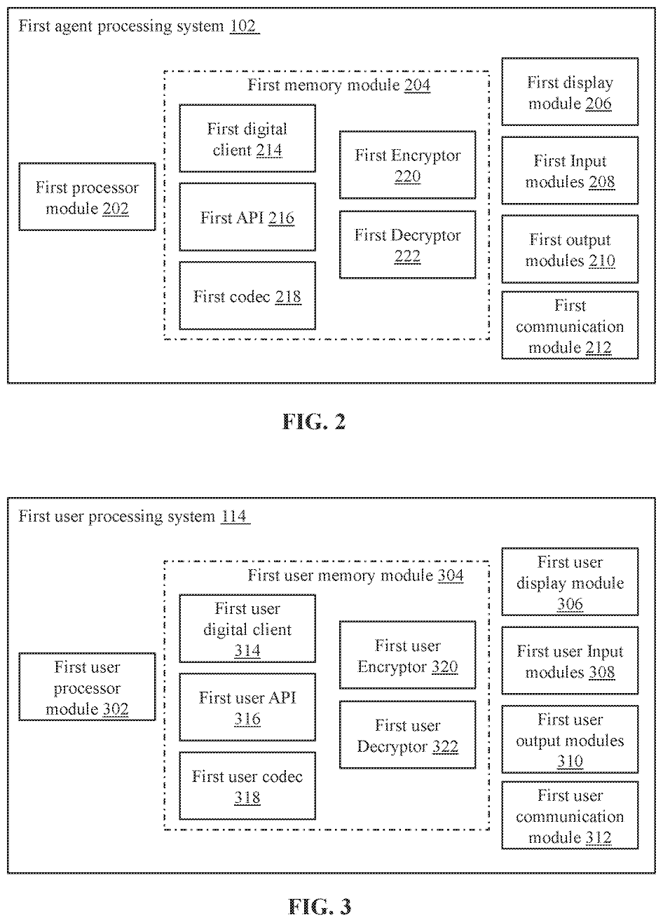

FIG. 2 is a block diagram illustrating architecture of the first agent processing system 102, in accordance with an embodiment. The first agent processing system 102 may comprise of a first processor module 202, a first memory module 204, a first display module 206, first input modules 208, first output modules 210, and a first communication module 212.

The first processor module 202 may be implemented in the form of one or more processors and may be implemented as appropriate in hardware, computer-executable instructions, firmware, or combinations thereof. Computer-executable instruction or firmware implementations of the first processor module 202 may include computer-executable or machine-executable instructions written in any suitable programming language to perform the various functions described.

The first memory module 204 may include a permanent memory such as hard disk drive. The first memory module 204 may be configured to store data, and executable program instructions that are implemented by the first processor module 202. The first memory module 204 may be implemented in the form of a primary and a secondary memory. The first memory module 204 may store additional data and program instructions that are loadable and executable on the first processor module 202, as well as data generated during the execution of these programs. Further, the first memory module 204 may be a volatile memory, such as random-access memory and/or a disk drive, or a non-volatile memory. The first memory module 204 may comprise of removable memory such as a Compact Flash card, Memory Stick, Smart Media, Multimedia Card, Secure Digital memory, or any other memory storage that exists currently or may exist in the future.

In an embodiment, the first memory module 204 may further comprise of a first digital client 214, a first Application Programming Interface (API) 216, a first codec 218, a first encryptor 220, and a first decryptor 222. The first digital client 214 may be a web browser or a software application enabling video or audio conferencing. The first digital client 214 may further comprise a first digital client display interface, wherein the first digital client display interface may enable the interaction of the first user 112 with the first agent processing system 102. The first codec 218 may include computer-executable or machine-executable instructions written in any suitable programming language to compress outgoing data and decompress incoming data. The first encryptor 220 may encrypt the outgoing data and first decryptor 222 may decrypt the incoming data.

The first display module 206 may display an image, a video, or data to a user. For example, the first display module 206 may include a panel, and the panel may be an LCD, LED or an AM-OLED.

The first input modules 208 may provide an interface for input devices such as keypad, touch screen, mouse, and stylus among other input devices. In an embodiment, the first input module 208 includes a camera and a microphone.

The first output modules 210 may provide an interface for output devices such as display screen, speakers, printer, and haptic feedback devices, among other output devices.

The first communication module 212 may be used by the first agent processing system 102 to communicate with the server 110. The first communication module 212, as an example, may be a GPRS module, or other modules that enable wireless communication.

It may be noted that the second agent processing system 106, may have a similar architecture as that of the first agent processing system 102, and is therefore not described in detail for the sake of brevity.

In an embodiment, the third agent processing system, the fourth agent processing system, and so on, may have a similar architecture as that of the first agent processing system 102, and are not described for the sake of brevity.

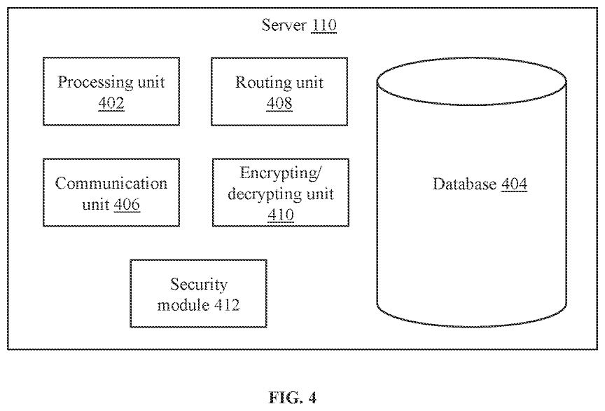

FIG. 3 is a block diagram illustrating architecture of the first user processing system 114, in accordance with an embodiment. The first user processing system 114 may comprise of a first user processor module 302, a first user memory module 304, a first user display module 306, first user input modules 308, first user output modules 310, and a first user communication module 312.

The first user processor module 302 may be implemented in the form of one or more processors and may be implemented as appropriate in hardware, computer-executable instructions, firmware, or combinations thereof. Computer-executable instruction or firmware implementations of the first user processor module 302 may include computer-executable or machine-executable instructions written in any suitable programming language to perform the various functions described.

The first user memory module 304 may include a permanent memory such as hard disk drive. The first user memory module 304 may be configured to store data, and executable program instructions that are implemented by the first user processor module 302. The first user memory module 304 may be implemented in the form of a primary and a secondary memory. The first user memory module 304 may store additional data and program instructions that are loadable and executable on the first user processor module 302, as well as data generated during the execution of these programs. Further, the first user memory module 304 may be a volatile memory, such as random-access memory and/or a disk drive, or a non-volatile memory. The first user memory module 304 may comprise of removable memory such as a Compact Flash card, Memory Stick, Smart Media, Multimedia Card, Secure Digital memory, or any other memory storage that exists currently or may exist in the future.

In an embodiment, the first user memory module 304 may further comprise of a first user digital client 314, a first user Application Programming Interface (API) 316, a first user codec 318, a first user encryptor 320, and a first user decryptor 322. The first user digital client 314 may be a web browser or a software application enabling video or audio conferencing. The first user digital client 314 may further comprise a first user digital client display interface, wherein the first user digital client display interface may enable the interaction of the first user 112 with the first user processing system 114. The first user codec 318 may include computer-executable or machine-executable instructions written in any suitable programming language to compress outgoing data and decompress incoming data. The first user encryptor 320 may encrypt the outgoing data and first user decryptor 322 may decrypt the incoming data.

The first user display module 306 may display an image, a video, or data to a user. For example, the first user display module 306 may include a panel, and the panel may be an LCD, LED or an AM-OLED.

The first user input modules 308 may provide an interface for input devices such as keypad, touch screen, mouse, and stylus among other input devices. In an embodiment, the first user input module 308 includes a camera and a microphone.

The first user output modules 310 may provide an interface for output devices such as display screen, speakers, printer, and haptic feedback devices, among other output devices.

The first user communication module 312 may be used by the first user processing system 114 to communicate with the server 110. The first user communication module 312, as an example, may be a GPRS module, or other modules that enable wireless communication.

In an embodiment, the second user processing system, the third user processing system, and so on, may have a similar architecture as that of the first user processing system 114, and are not described for the sake of brevity.

FIG. 4 is a block diagram illustrating an architecture of the server 110, in accordance with an embodiment. The server 110 may comprise of a processing unit 402, a database 404, a communication unit 406, a routing unit 408, an encrypting/decrypting unit 410, and a security module 412.

The processing unit 402 may be implemented in the form of one or more processors and may be implemented as appropriate in hardware, computer-executable instructions, firmware, or combinations thereof. Computer-executable instruction or firmware implementations of the processing unit 402 may include computer-executable or machine-executable instructions written in any suitable programming language to perform the various functions described.

The database 404 may include a permanent memory such as hard disk drive, that may be configured to store data, and executable program instructions that are implemented by the processor module. The database 404 may be configured to store information related to the first agent 104, the second agent 108, the third agent, and so on, which may be, but not limited to, email ID/phone number associated with the agents, and information pertaining to the first agent processing system 102, the second agent processing system 106, the third agent processing system and so on. Further, the database 404 may be configured to store information related to the first user 112, the second user, the third user, and so on, which may be, but not limited to, email ID/phone number associated with the users, and information pertaining to the first user processing system 114, the second user processing system, the third user processing system and so on.

The communication unit 406 may be used by the server 110 to communicate with a plurality of agent processing systems (such as the first agent processing system 102, the second agent processing system 106, and so on), and a plurality of user processing systems (such as the first user processing system 114, the second user processing system, and so on). The communication unit 406, as an example, may be a GPRS module, or other modules that enable wireless communication.

The routing unit 408 may be configured to enable identification of the plurality of agent processing systems and the plurality of user processing systems to which the data must be transmitted.

The encrypting/decrypting unit 410 may be configured to decrypt the incoming data and encrypt the outgoing data from the server 110 from each of the plurality of agent processing systems and the plurality of user processing systems.

The security module 412, before establishing a connection, may be configured to authenticate each of plurality of agents (such as the first agent 104, the second agent 108, and so on) and a plurality of users (such as the first user 112, the second user, and so on) associated with each of the plurality of agent processing systems and the plurality of user processing systems, respectively.

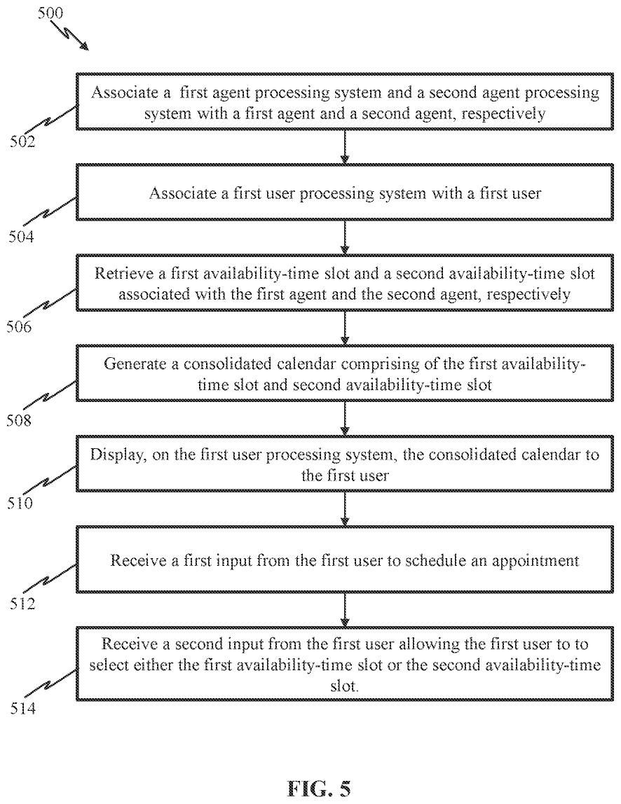

FIG. 5 is a flowchart 500 illustrating scheduling of the appointment via the system 100, in accordance with an embodiment. At step 502, the server 110 may be configured to associate the first agent processing system 102 and the second agent processing system 106 with the first agent 104 and the second agent 108, respectively.

At step 504, the server 110 may be configured to associate the first user processing system 114 with the first user 112.

At step 506, the server 110 may be configured to retrieve a first availability-time slot associated with the first agent 104 and a second availability-time slot associated with the second agent 108. During the first availability-time slot and the second availability-time slot, an availability status associated with the first agent 104 and the second agent 108 are Available.

At step 508, the server 110 may be configured to generate the consolidated calendar. The consolidated calendar may comprise of the first availability-time slot and the second availability-time slot.

At step 510, the server 110 may be configured to display, on the first user processing system 114, the consolidated calendar to the first user 112.

In an embodiment, the server 110 may be configured to hide personal information of the first agent 104 and the second agent 108 from the first user 112, wherein personal information may include, but not limited to, Name, Age, user ID, reference number associated with the first agent 104 and the second agent 108.

At step 512, the server 110 may be configured to receive a first input from the first user 112 to schedule an appointment.

At step 514, the server 110 may be configured to receive a second input from the first user 112. The second input may allow the first user 112 to select either the first availability-time slot or the second availability-time slot.

In an embodiment, the server 110 may be configured to notify the first agent 104, when the first user 112 selects the first availability-time slot. Further, the server 110 may be configured to receive a third input from the first agent 104 confirming the appointment. Upon receiving the third input, the server 110 may be configured to notify the first user 112, confirming the appointment.

In another embodiment, the server 110 may be configured to notify the second agent 108, when the first user 112 selects the second availability-time slot. Further, the server 110 may be configured to receive a third input from the second agent 108 confirming the appointment. Upon receiving the third input, server 110 may be configured to notify the first user 112, confirming the appointment.

In another embodiment, the server 110 may be configured to notify the first agent 104, when the first user 112 selects the first availability-time slot. Further, the server 110 may be configured to notify the first user 112 with the confirmation of the appointment. In other words, the server 110 may be configured to automatically assign the first agent 104, when the first user 112 selects the first availability-time slot.

In another embodiment, the server 110 may be configured to notify the second agent 108, when the first user 112 selects the second availability-time slot. Further, the server 110 may be configured to notify the first user 112 with the confirmation of the appointment. In other words, the server 110 may be configured to automatically assign the second agent 108, when the first user 112 selects the second availability-time slot.

In an embodiment, the server 110 may be configured to display, on the first user processing system 114, the availability status associated with the first agent 104 or the second agent 108. The availability status further comprises of Away, Busy, Do Not Disturb and Offline.

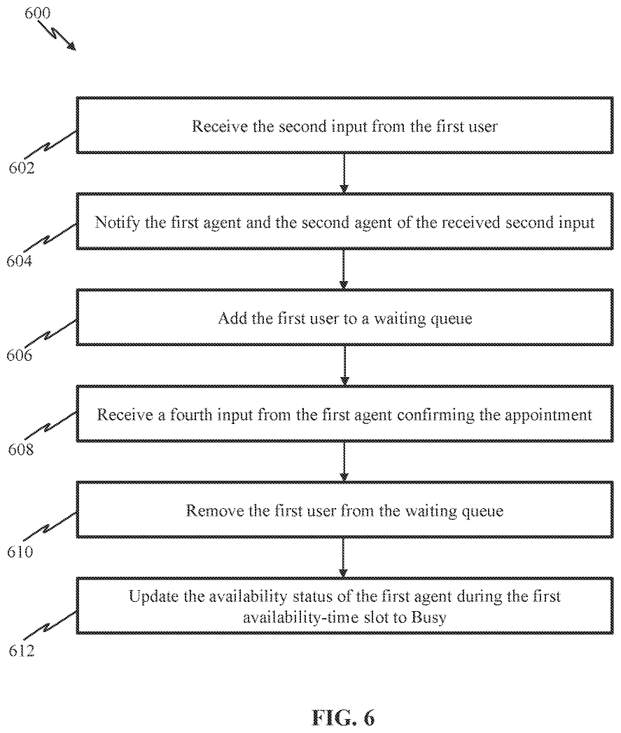

FIG. 6 is a flowchart 600 illustrating scheduling of the appointment when the first availability-time slot aligns with the second availability-time slot, in accordance with an embodiment. At step 602, when the first availability-time slot aligns with the second availability-time slot, the server 110 may be configured to receive the second input from the first user 112. The second input may allow the first user 112 to select either the first availability-time slot or the second availability-time slot.

At step 604, upon receiving the second input, the server 110 may be configured to notify the first agent 104 and the second agent 108 of the received second input.

At step 606, the server 110 may be configured to add the first user 112 to a waiting queue.

In an embodiment, the server 110 may be configured to display the waiting queue to the first agent 104, and the second agent 108.

At step 608, the server 110 may be configured to receive a fourth input from the first agent 104 confirming the appointment.

In an embodiment, the server 110 may be configured to receive the fourth input from the second agent 108 confirming the appointment.

At step 610, upon receiving the fourth input, the server 110 may be configured to remove the first user 112 from the waiting queue.

At step 612, the server 110 may be configured to update the availability status of the first agent 104 during the first availability-time slot, from Available to Busy.

In an embodiment, the server 110 may be configured to update the availability status of the second agent 108 during the second availability-time slot, from Available to Busy.

In an embodiment, upon adding the first user 112 to the waiting queue and after a preset time, the server 110 may configured to notify the first agent 104 and the second agent 108 the presence of the first user 112 in the waiting queue.

In an embodiment, the server 110 may be configured to receive the preset time from the first agent 104 or the second agent 108.

In an embodiment, the server 110 may be configured to notify the first user 112 upon receiving the fourth input by the first agent 104 or the second agent 108, confirming the appointment with the first user 112.

In an embodiment, the server 110 may be configured to notify the first user 112 at least once before the time of the scheduled appointment. The term “notifying at least once before the time of the appointment” may be defined as, but not limited to, sending notifications or alerts to the first user 112 on multiple time intervals. (For example: if the appointment is set for 4:00 PM, notifications could be sent at multiple time intervals, such as commencing at 9:00 AM and continuing every 2 hours thereafter, and additionally at 3:30 PM and 3:45 PM, thereby informing the first user 112 of the impending 4:00 PM appointment.

In one embodiment, the server 110 may be configured to retrieve and store scheduled appointments associated with each of the plurality of users in the waiting queue. The server 110 may configured to display the waiting queue on both the first agent processing system 102 and the second agent processing system 106. The first agent 104 may select any one of the user's appointments from the waiting queue. If the first agent 104 selects the first user 112 before the second agent 108, the first user's appointment is removed from the waiting queue, thereby confirming the scheduled appointment with the first user 112. Meanwhile, the appointments of rest of the users from the plurality of users in the waiting queue are displayed on the second agent processing system 106.

In an example embodiment, if the first user 112 and the second user have both selected the time slot from 9 AM to 10 AM, while the third user and the fourth user have selected the time slot from 11 AM to 12 PM, the first agent 104, accessing the waiting queue before the second agent 108, may select either the first user or the second user from the 9 AM to 10 AM time slot. When the first agent 104 accepts the appointment request received from the first user 112, the first user's appointment is removed from the waiting queue, and the second user's appointment is displayed on the top in the waiting queue. Similarly, for the time slot from 11 AM to 12 PM, the second agent 108, accessing the waiting queue before the first agent 104, the second agent 108 may select either the third user or the fourth user. If the second agent 108 accepts the appointment request received from the third user, the third user receives a confirmation notification from the server. Further, the fourth user's appointment is displayed on the top in the waiting queue.

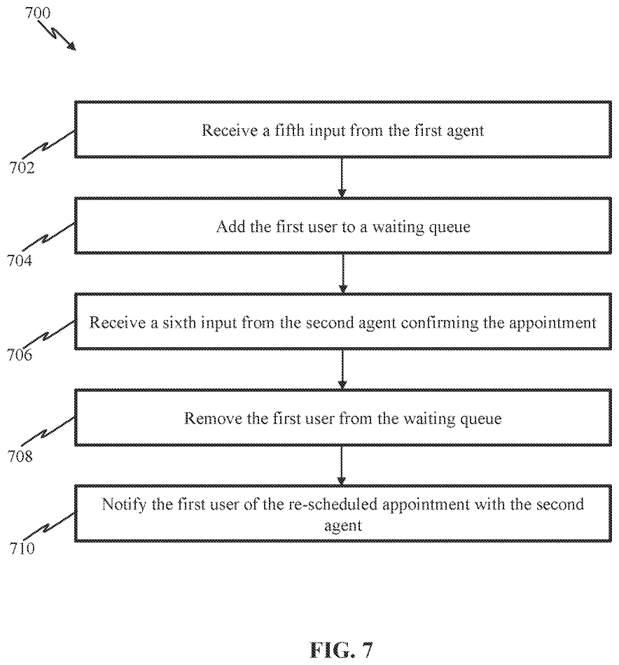

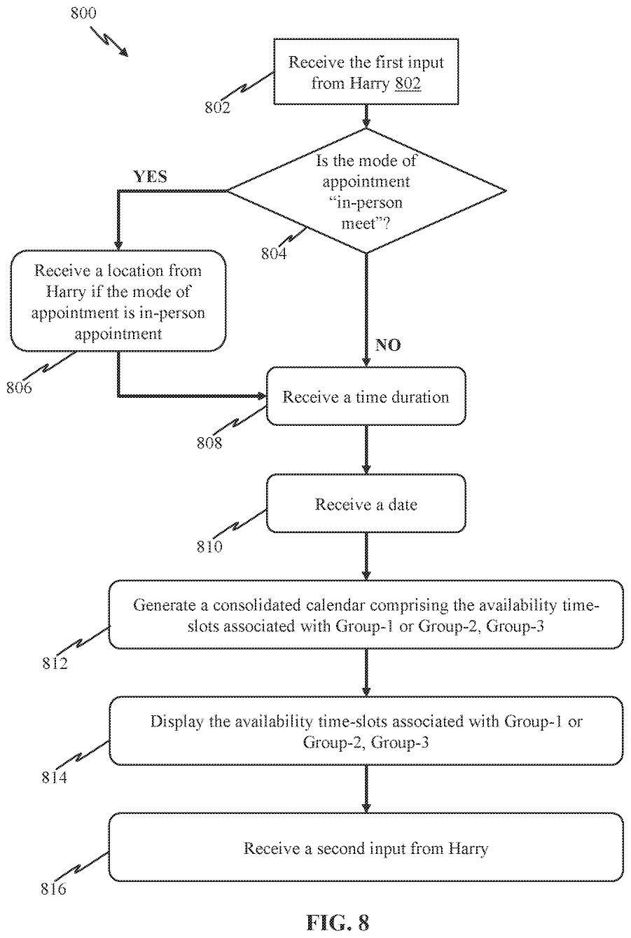

FIG. 7 is a flowchart 700 illustrating re-scheduling the appointment of the first user 112 by the first agent 104, in accordance with an embodiment. At step 702, when the first agent 104 confirms the appointment with the first user 112, the server 110 may be configured to receive a fifth input from the first agent 104. The fifth input may be an instruction from the first agent 104 to delete the confirmed appointment of the first user 112 from the first agent's processing system 102.

At step 704, upon receiving the fifth input from the first agent 104, the server 110 may be configured to delete the confirmed appointment of the first user 112 and add the first user 112 to the waiting queue.

At step 706, the server 110 may be configured to receive a sixth input from the second agent 108 confirming the appointment of the first user 112.

At step 708, the server 110 may be configured to remove the first user 112 from the waiting queue, upon the second agent 108 confirming the appointment with the first user 112.

At step 710, the server 110 may be configured to notify the first user 112 of the re-scheduled appointment with the second agent 108.

In an embodiment, the server 110 may be configured to receive the first input from the first user 112 to schedule the appointment, wherein the scheduling of the appointment is based on the consolidated calendar comprising the first availability-time slot, the second availability-time slot, the third availability-time slot, and so on. The first input may include, but not limited to, a date and time of the appointment, a duration of the appointment, a mode of appointment. The system 100 may further comprise of a date and time indicator, a duration indicator, an in-person meeting indicator, a video call indicator, and an audio call indicator. The consolidated calendar may comprise of the date and time indicator, wherein the date and time indicator allow the first user 112 to define a specific date and time for the appointment. The duration indicator may be configured to allow the first user 112 to define the duration of the appointment, wherein the server 110 may be configured to allow the first user 112 to select the duration for the appointment. The in-person meeting indicator may be configured to allow the first user 112 to schedule an appointment for an in-person meeting. The video call indicator may be configured to allow the first user 112 to schedule an appointment for a video call. The audio call indicator may be configured to allow the first user 112 to schedule an appointment for an audio call.

In an embodiment, the server 110 may be configured to receive the date and the duration of the appointment from the first user 112. The server 110 may be configured to receive a request from the first user 112, requesting for the video call via the video call indicator. The server 110 may be configured to display, on the first user processing system 114, the consolidated calendar comprising the first availability-time slot and the second availability-time slot, wherein mode of appointment associated with the first agent 104, or the second agent 108 is set to video call.

In an embodiment, the server 110 may be configured to receive a request from the first user 112, requesting for the audio call via the audio call indicator.

In an embodiment, the server 110 may be configured to receive the date and the duration of the appointment from the first user 112. The server 110 may be configured to receive a request for in-person meeting via the in-person meeting indicator. Upon receiving the request, the server 110 may be configured to receive details of a location for the in-person meeting from the first user 112. Further, the server 110 may be configured to display, on the first user processing system 114, the consolidated calendar comprising the first availability-time slot, wherein mode of appointment associated with the first agent 104 is set to in-person meeting and the first agent is associated with the location i.e., the first agent 104 is employed to provide services/assistance in the proximity of the location shared by the first user 112.

In an embodiment, the server 110 may be configured to retrieve the first availability-time slot and the second availability-time slot from the database 404 at pre-defined intervals. In other words, the server 110 may be configured to automatically synchronize and update the consolidated calendar periodically.

In an embodiment, the server 110 may be further configured to retrieve the first availability-time slot and the second availability-time slot from plurality of sources, wherein the plurality of sources may be configured to store the availability status of the first agent 104 and the second agent 108. The plurality of sources may include, but not limited to, a social media platform (such as Facebook, LinkedIn, Tweeter, etc.), organizational account, and similar platforms.

### Example-1

In accordance with an example embodiment, a company known as “XYZ” employs 25 agents. Said 25 agents within the XYZ organization may be categorized into two or more distinct groups, namely Group-1, Group-2, and Group-3, each belonging to different departments. For instance, Group-1 may be tasked with providing user support services, while Group-2 may be responsible for addressing finance-related issues. Additionally, Group-3 may be designated to manage tasks such as supporting installations, customizations, maintenance, and product upgrades, among others.

Further, mode of appointment for all the agents in Group-1 may be configured for video call appointments, mode of appointment for all the agents in Group-2 may be configured for audio call appointments, and mode of appointment for all the agents in Group-3 may be configured for in-person call appointments. Let's assume, John and Alex are part of Group-1, Clark and Peter are part of Group-2, and Bruce and Billy are part of Group-3.

Harry and Kerry are customers associated with XYZ. Harry associated with Harry's system, wishes to schedule an appointment with Group-1 requiring user support services. FIG. 8 is a flowchart 800 illustrating scheduling of the appointment, in accordance with an example embodiment. At step 802, the server 110 may be configured to receive a first input from Harry requesting to schedule an appointment. Upon receiving the first input, the server 110 is configured to establish a secured connection between Harry's system and the server 110.

Upon establishing the secured connection, at step 804, the server 110 is configured to receive the mode of appointment from Harry. The mode of appointment may include, but not limited to, in-person appointments, video call appointments, and audio call appointments.

At step 806, if Harry selects the in-person appointment, the server 110 may be configured to receive the location details from Harry, specifying where the in-person appointment should occur.

At step 808, if Harry selects either the audio call appointment or the video call appointment, the server 110 may be configured to receive the appointment duration. Furthermore, the server 110 may also be configured to receive the appointment duration from Harry if Harry has selected for an in-person appointment.

At step 810, the server 110 may be configured to receive the date for the appointment.

At step 812, the server 110 may be configured to generate the consolidated calendar, which includes available time slots associated with the agent of Group-1 or Group-2 or Group-3 based on the mode of appointment.

At step 814, the sever 110 may be configured to display the the availability timeslots associated with Group-1 or Group-2, Group-3 to Harry.

In an example embodiment, if Harry selects the in-person appointment, the server 110 may be configured to display the availability time-slots of Bruce and Billy. Further, if Harry selects the video call appointment, the server 110 may be configured to display the availability timeslots of John and Alex. Furthermore, if Harry selects the audio call appointment, the server 110 may be configured to display the availability timeslots of Clark and Peter.

At step 816, the sever 110 may be configured to receive the second input from Harry. If Harry selects the in-person appointment, the server 110 may be configured to receive the second input from Harry, wherein the second input allows Harry to select either Bruce's availability time-slot or Billy's availability time-slot. Further, if Harry selects the video call appointment, the server 110 may be configured to receive a second input from Harry, wherein the second input allows Harry to select either John's availability timeslot or Alex's availability timeslot. Furthermore, if Harry selects the audio call appointment, the server 110 may be configured to receive a second input from Harry, wherein the second input allows Harry to select either Clark's availability timeslot or Peter's availability timeslot.

In an embodiment, Kerry, associated with Kerry's system, desires to schedule an appointment with Group-2. If Kerry is unable to find an available time slot for Clark and Peter, the server is configured to allow Kerry to request to be added to the waiting queue.

### Example-2

In a continuation example, when Harry schedules the appointment with Group-3, wherein John's availability-time slot coincides with Alex's availability-time slot, the server 110 may be configured to notify both John's system and Alex's system. Further, the server 110 may place Harry in the waiting queue until either John or Alex accepts the request from Harry for the appointment. If John confirms Harry's appointment before Alex, the server 110 may be configured to remove Harry's appointment from the waiting queue and notify Harry of the confirmation of the scheduled appointment. Upon confirming Harry's appointment, the server 110 updates John's availability-time slot from ‘Available’ to ‘Unavailable’ or ‘Busy’.

### Example-3

In a continuation example, John wishes to cancel the confirmed appointment with Harry. The server 110 may be configured to reintroduce Harry's appointment into the waiting queue while removing it from John's calendar. On a later time, Alex may confirm the appointment, prompting the server 110 to notify Harry about the rescheduled appointment. Similarly, the server 110 is configured to allow Alex to confirm the appointment of plurality of users requested appointments (added to the waiting queue). The server 110 may be configured to provide notification to Harry regarding the appointment confirmation without disclosing the identities of John and Alex involved.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and process or method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for an integrated team calendar, the system comprising:
a first agent processing system associated with a first agent;
a second agent processing system associated with a second agent;
a first user processing system associated with a first user; and
a server comprising one or more processors, wherein the server is configured to:
retrieve a first availability-time slot associated with the first agent;
retrieve a second availability-time slot associated with the second agent, wherein availability status associated with the first agent and the second agent during the first availability-time slot and the second availability-time slot is Available;
generate a consolidated calendar comprising of the first availability-time slot and the second availability-time slot; and
display, on the first user processing system, the consolidated calendar to the first user.

2. The system according to claim 1, wherein the server is configured to:
receive a first input from the first user to schedule an appointment; and
receive a second input from the first user, wherein the second input allows the first user to select either the first availability-time slot or the second availability-time slot.

3. The system according to claim 2, wherein the server is configured to:
notify the first agent, when the first user selects the first availability-time slot;
receive a third input from the first agent confirming the appointment; and
notify the first user upon receiving the third input confirming the appointment.

4. The system according to claim 2, wherein the server is configured to:
notify the first agent, when the first user selects the first availability-time slot; and
notify the first user with the confirmation of the appointment.

5. The system according to claim 2, wherein the server is configured to display, on the first user processing system, the availability status of the first agent and the second agent, wherein the availability status is any one of Away, Busy, Do Not Disturb and Offline.

6. The system according to claim 5, wherein when the first availability-time slot aligns with the second availability-time slot, the server is configured to:
receive the second input from the first user;
notify the first agent and the second agent of the received second input;
add the first user to a waiting queue;
receive a fourth input from the first agent or the second agent confirming the appointment;
remove the first user from the waiting queue; and
update the availability status of the first agent or the second agent during the first availability-time slot or the second availability-time slot, from Available to Busy, based on the fourth input.

7. The system according to claim 6, wherein upon adding the first user to the waiting queue and after a preset time, the server is configured to notify the first agent and the second agent of first user in the waiting queue.

8. The system according to claim 6, wherein the server is configured to notify the first user upon receiving the fourth input confirming the appointment with the first user.

9. The system according to claim 8, wherein the server is configured to notify the first user at least once before the time of the scheduled appointment.

10. The system according to claim 8, wherein when:
the first agent confirms the appointment with the first user; and
the server receives a fifth input from the first agent, the server is configured to:
add the first user to the waiting queue;
receive a sixth input from the second agent confirming the appointment of the first user with the second agent; and
notify the first user of the re-scheduled appointment with the second agent.

11. The system according to claim 1, wherein,
a date and time indicator is displayed on the first user processing system to allow the first user to define a date and time of the appointment;
a duration indicator is displayed on the first user processing system to allow the first user to define a time duration of the appointment;
an in-person meeting indicator is displayed on the first user processing system to allow the first user to schedule an appointment for an in-person meeting;
a video call indicator is displayed on the first user processing system to allow the first user to schedule an appointment for a video call; and
an audio call indicator is displayed on the first user processing system to allow the first user to schedule an appointment for an audio call.

12. The system according to claim 11, wherein upon receiving:
the date of the appointment from the first user;
the time duration of the appointment from the first user; and
a request for the video call via the video call indicator, the server is configured to display, on the first user processing system, the consolidated calendar comprising the first availability-time slot and the second availability-time slot, wherein mode of appointment associated with the first agent and the second agent is set to video call.

13. The system according to claim 11, wherein upon receiving:
the date of the appointment from the first user;
the time duration of the appointment from the first user; and
a request for in-person meeting via the in-person meeting indicator, the server is configured to:
request and receive location details from the first user;
display, on the first user processing system, the consolidated calendar comprising the first availability-time slot, wherein:
mode of appointment associated with the first agent is set to in-person meeting; and
the first agent is associated with the location.

14. The system according to claim 1, wherein the server is configured to retrieve the first availability-time slot and the second availability-time slot from a database at pre-defined intervals.

15. The system according to claim 14, wherein the server is further configured to retrieve the first availability-time slot and the second availability-time slot from plurality of sources, wherein the plurality of sources is configured to store the availability status of the first agent and the second agent.

16. A method for an integrated team calendar, the method comprising:
associating a first agent processing system with a first agent;
associating a second agent processing system with a second agent;
associating a first user processing system with a first user;
retrieving, by the server, a first availability-time slot associated with the first agent;
retrieving, by the server, a second availability-time slot associated with the second agent, wherein an availability status associated with the first agent and the second agent, during the first availability-time slot and the second availability-time slot, is Available;
generating, by the server, a consolidated calendar comprising of the first availability-time slot and second availability-time slot; and
displaying on the first user processing system, by the server, the consolidated calendar to the first user.

17. The method according to claim 16 comprising:
receiving, by the server, a first input from the first user to schedule an appointment; and
receiving, by the server, a second input from the first user, wherein the second input allows the first user to select either the first availability-time slot or the second availability-time slot.

18. The method according to claim 17 comprising:
receiving, by the server, the second input from the first user;
notifying, by the server, the first agent and the second agent of the received second input;
adding, by the server, the first user to a waiting queue;
receiving, by the server, a fourth input from the first agent or the second agent confirming the appointment;
removing, by the server, the first user from the waiting queue; and
updating, by the server, the availability status of the first agent or the second agent during the first availability-time slot or the second availability-time slot, from Available to other than Available, based on the fourth input.
